(19) United States
(12) Patent Application Publication
(10) Pub. No.: US 2002/0131697 A1
(43) Pub. Date: Sep. 19, 2002

(54) Technique and apparatus for compensating for variable lengths of terminated optical fibers in confined spaces

(76) Inventors: Scott Michael Branch, Rochester, MN (US); Michael Francis Hanley, Rochester, MN (US); Gary Lee Heitkamp, Rochester, MN (US); William K. Hogan, Rochester, MN (US)

Correspondence Address: CHARLES E. WANDS, MESSRS ALLEN DYER DOPPELT MILBRATH & GILCHRIST, 1401 CITRUS CENTER, 255 SOUTH ORANGE AVENUE, PO BOX 3791, ORLANDO, FL, 32802-3791, US

(21) Appl. No.: 09/809,531

(22) Filed: Mar. 15, 2001

(51) Int. Cl. G02B 6/26

(52) U.S. Cl. 385/31; 385/15

(57) ABSTRACT

An optical fiber may be used to interconnect two optical devices precisely disposed at a fixed distance with a fiber substantially larger than the inter-device distance with substantial disregard to tolerancing of the length dimension of the optical fiber so long as the optical fiber maintains a bend radius in excess of the minimum bend radius required for that optical fiber. This is accomplished by forming a loop in the optical fiber. Any increase in specified length of an optical fiber does not require a corresponding increase in available space inasmuch as the radius of the loop will increase only approximately ⅙ of the length increase. This looping permits lengthened optical fibers and relaxed tolerances permitting use of less expensive optical fibers with no sacrifice in performance quality.

### FIELD OF THE INVENTION

This invention relates to the interconnection of small devices in either a transmitter or receiving optical sub-assembly and, more specifically, to the interconnection of optical components spaced apart at a precisely predetermined distance, thereby not requiring highly toleranced optical fibers.

### BACKGROUND OF THE INVENTION

Optical fiber networks for interconnecting computer servers and other data processing systems require the connection or interfacing of an optical fiber of the network to the computer or the like in a manner that an optical signal may be received and processed by the computer or transmitted from the computer to the network and other computers, routers and switches.

Computers are used only as a general example; similarly, servers or any electronic device capable of receiving and/or sending optical signals require connections or interfaces for attachment to optical fiber signal conductors.

The transmission of optical signals requires the conversion of the electronic computer signals to optical signals by a transmission optical subassembly (TOSA), typically by means of a laser. The laser usually is contained within an enclosure into which an optical fiber extends to a point juxtaposed with the laser output.

Similarly, a receiver optical sub-assembly (ROSA) has either a photo-detector positioned within the enclosure or a separate enclosure and, in either instance, has a separate optical fiber extending from near the face of the photo-detector to and through a wall of the enclosure.

The precise placement of the optical element, laser or photo detector within the enclosure is dictated by the circuit substrate electronically connecting the opto-electronic devices to the computer circuitry. The specified distance provided between the opto-electronic devices to the inner end of a connection ferrule extending through the wall of the enclosure typically is very tightly controlled both by specifying a fixed dimension and very narrow tolerance range.

Optical fibers used must be cleaved and polished on the ends to provide minimum light loss or signal loss upon light entry into or exit from an optical fiber. Due to the varying length of the optical fiber prior to polishing and/or varying amounts of fiber removed during the polishing, the cleaving operation and the further necessary polishing does not permit very precise control of the length of a finished optical fiber in an economical manner. Accordingly, the specified length of optical fibers is extremely difficult to control with precision. Economically, the cost of very closely toleranced lengths of optical fibers is often double the cost of a finished optical fiber having a length tolerance only slightly increased in term of length.

However, any slight increase in the toleranced length of the optical fiber is not and cannot be an acceptable solution because, whenever considered with a relatively short specified length of optical fiber, a slight increase in length causes the optical fiber to buckle in an uncontrolled manner. Additionally, it commonly results in an optical fiber being bent to a bend radius less than the minimum bend radius that an optical fiber can experience without cracking or breaking, thereby resulting in interruption or degradation of the light path and optical signal.

FIGS. 1 and 2 are illustrative of examples of the form that an optical fiber may take with various worst case dimensions within tolerance ranges of 1.0 mm. and 2.0 mm., respectively, for an optical fiber with a specified nominal length of 12.0 mm.

With the increased cost of the more finely toleranced optical fiber length, there is a economic motivation to loosen the tolerance range. To loosen the tolerance range, effectively doubling the range, requires a larger specified base dimension in order to insure the shortest, within tolerance, optical fiber will span the distance between the devices being connected.

The longest acceptable optical fiber, including the largest acceptable plus tolerance would result in a fiber that would buckle and bend as shown in FIG. 1. The fiber assumes a series of bends which each have a radius greater than the specified minimum bend radius for any particular optical fiber.

The longer the fiber is, as in the buckled or kinked form shown in FIG. 1, the sharper the bends. As compared to FIG. 1, FIG. 2 illustrates how only 1.0 mm is added to each of the +/− tolerances affects the bends of the fiber while maintaining the worst case shortest dimension.

Manufacturers of optical fibers, such as Corning Corp. of Corning, N.Y., specify a minimum bend radius for their fibers. While the specified, minimum bend radius typically is stated for a fiber with jacket, the actual fiber with buffer, without the jacket, may have a minimum bend radius substantially less than that specified by the manufacturer; such radius is capable of determination and should be determined by experimentation. Such experimentation simply would be bending the fiber to determine at what bend radius the fiber ceased to function as an efficient conductor. A safety factor could be added then to the observed bend radius to insure further reliability and specifically stated as a minimum bend radius for the selected optical fiber. Each optical fiber minimum bend radius will vary depending upon the diameter and other potential variables from size to size.

The free path of the fiber in this illustration may be subdivided into three segments, an exit run extending from each of the devices and a mid run. The exit runs in FIGS. 1 and 2 extend from the point that the optical fiber is unsupported after exiting from the electro-optic device to a point where the fiber transitions from a curve to a straight section or a point at which the curvature reverses. The mid run extends from the curvature reversal transition point to the curvature reversal transition point associated with the second exit run and the second connected device.

The curvature or bend radius of the exit runs will decrease as the length of the fiber increases and the buckle in the optical fiber becomes more pronounced. At some point, the buckle will force one or more of the fiber runs to assume a radius that is too sharp and too small to allow the fiber to effectively function as a light transmission path. The failure may be caused by the cracking or breaking in the bend or, in some cases, a loss of light through the side wall of the optical fiber.

The issue of reliability becomes controlling over cost whenever the change from a tight and expensive tolerance range is specified and the loosening of the tolerance range to reduce cost produces a bend radius that either fails or jeopardizes the functionality of the light conducting fiber.

### OBJECTS OF THE INVENTION

It is an object of the invention to permit a more economical tolerancing of optical fiber while, at the same time, avoiding formation of an optical fiber into a configuration which is highly likely to fail.

It is another object of the invention to permit use of the economically acquired optical fiber in a connection between closely spaced optical devices without causing a bend to jeopardize the functional integrity of the optical fiber.

It is a further object of the invention to interconnect optical devices which are closely spaced with an optical fiber that is substantially longer than the separation distance between the optical devices.

It is a still further object of the invention to provide design latitude in the placement of optical devices within an optical assembly and their orientation relative to each other.

Other Objects of the Invention will become apparent to one of skill in the art once the invention is understood.

The foregoing objects of the invention are not intended to limit the scope of the invention in any manner.

### SUMMARY OF THE INVENTION

This invention overcomes problems presented by the art as described in the Background of the Invention and accomplishes the Objects of the Invention as summarized at this point.

Where an interconnection of two optical devices, such as an optical sub-assembly and a connecting optical fiber ferrule, is accomplished over a small distance, the connection may be made by using an optical fiber which is an imprecise multiple of the separation distance between the points on each optical device.

Where the optical devices are positioned with the optical fiber exit points aligned and facing each other, the optical fiber used may be one having a length equal to or greater than the sum of the circumference of a circle having a radius equal to or greater than the minimum bend radius of the optical fiber and the inter-device spacing intermediate the two connected devices.

The circle or loop of optical fiber will have a sufficiently large bend radius so as not to be either cracked or broken and not so sharply bent that the transmitted light is dissipated by scatter and lost through the surface of the optical fiber.

For optical devices which are disposed and positioned within the electro-optical assembly and where the axes of exit for the interconnecting optical fibers intersect, the axes form angles that are acute, obtuse or perpendicular. The technique of looping the optical fiber also may be used for such placements.

For perpendicular intersecting exit axes, the fiber must have a length not less than the sum of ¾ of the circumference of a circle having a radius equal to the minimum bending radius for the particular optical fiber and the distance from each optical device through the crossover point plus twice the distance from the crossover point to the tangent points of the circle whenever the circle is located with tangent points on both exit axes.

Similarly, wherever the optical devices are positioned such that the exit axis of each intersect at an acute or obtuse angle, the optical fiber must be of a length not less than the sum of the distances from each device to the crossover point of the axes, plus the distance from the crossover point to the tangent point on a circle which each of the exit axis is tangent thereto, and the circumference of the larger portion of the circumference of the arc between the two tangent points and the radius of the circle is equal to the minimum bending radius for a particular optical fiber.

The optical devices, if desired, could be disposed with their exit faces and exit ports opposingly oriented and co-planar, with the exit ports spaced apart laterally within the common plane. In this embodiment, the length of the optical fiber must be not less than the length of a helical path having a pitch equal to the distance between the exit ports and a radius equal to the minimum bending radius for the particular optical fiber.

The optical fibers for each of the above summarized embodiments require a length of fiber that is constrained by a minimum and is relatively unconstrained with respect to the maximum length.

Accordingly, once a nominal length is determined, the length may be specified as the nominal length with a minus tolerance of zero and a plus tolerance of a value which permits economical fabrication.

The discussed lengths of the optical fibers account only for that span of the optical fiber exterior to the optical devices. If the fiber extends into the optical devices, as is common, the maximum length of the optical fiber extending within each device must be added to the minimum lengths of the interconnecting optical fiber span to arrive at the overall specified minimum length.

The dimensions determined and, particularly, the minimum length of the optical fiber used to form the exit runs and the loop of optical fiber are critical to this invention and its reliable and proper operability.

If the length of the interconnecting span is less than the minimum length, the minimum bending radius value not only will exceed the actual radius of the bends of the fiber but also will subject fiber to cracking and breakage or light scatter failure.

A more complete and detailed understanding of the invention may be found in the attached drawings and the Detailed Description of the Invention which follows.

This Summary of the Invention is provided only as a summary and is not intended to nor should it be used for limiting the invention in any manner.

### BRIEF DESCRIPTION OF THE DRAWINGS

FIG. 1 is an illustration of an optical fiber interconnection wherein the length of the optical fiber is in excess of the inter-device distance by an amount within a tolerance range specified for the length of the optical fiber.

FIG. 2 is an illustration of an optical fiber interconnection wherein the length of the optical fiber is in excess of the inter-device distance by an amount within a wider tolerance range than in FIG. 1.

FIG. 3 is an isometric view of an optical transceiver unit with an optical fiber connecting an electro-optical transmission unit and its connection ferrule and a second optical fiber connecting an electro-optical receiving unit and its connection ferrule, wherein the optical fibers are of optimum length.

FIG. 4 illustrates a top view of an opto-electronic unit and its connection ferrule interconnected with an optical fiber of the invention.

FIG. 5. Illustrates a top view of an opto-electronic unit and its connection ferrule interconnected with an optical fiber of a second embodiment of the invention.

FIG. 6 illustrates a top view of an opto-electronic unit and its connection ferrule interconnected with an optical fiber of a third embodiment of the invention.

FIG. 7 illustrates a top view of an opto-electronic unit and its connection ferrule interconnected with an optical fiber of a fourth embodiment of the invention.

FIG. 8 is a side view of an opto-electronic unit and its connection ferrule interconnected with an optical fiber of the embodiment of FIG. 4.

FIG. 9 is an isometric view of opto-electronic devices interconnected by an optical fiber of the invention wherein the exit ports of the opto-electronic devices are positioned with the exit ports co-planar and at different elevations.

The drawings are provided as illustrations only to aid in understanding the invention and are not intended to be limiting of the invention in any manner.

### DETAILED DESCRIPTION OF BEST MODE OF THE PREFERRED EMBODIMENT OF THE INVENTION AS CONTEMPLATED BY THE INVENTORS

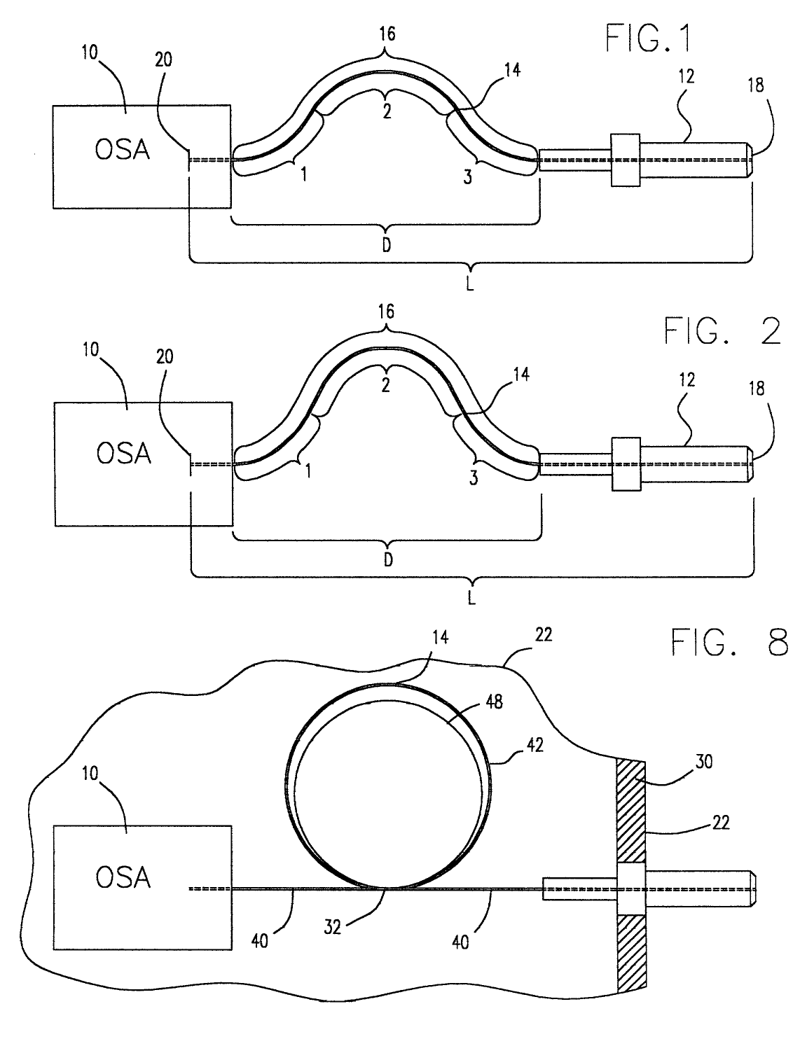

With initial reference to FIG. 1, an optical-electronic device 10 or an optical sub-assembly 10 (OSA) is shown interconnected with a connection ferrule 12. The interconnection is accomplished with an optical fiber 14. Note, where identical or functionally similar elements are illustrated in different figures of the drawing, common reference numerals are used. The term optical sub-assembly (OSA) as used in the specification and claims encompasses routers and switches as well as other fiber optic devices for transmitting optical signals.

The optical fiber 14 forms a span 16 extending between the OSA 10 and ferrule 12. Due to the fact that the span 16 of optical fiber 14 must be no shorter than the displacement d between the OSA 10 and ferrule 12, the optical fiber 14 must be specified at such a length that the optical fiber 14 is capable of extending from the end 18 of ferrule 12 to a predetermined datum line 20 within OSA 10.

After the length, l, is determined, the optical fiber 14 may be specified as nominally l+½ of a +/−1 mm tolerance factor so that if the optical fiber 14 is actually the specified length (l) minus the maximum negative tolerance, the optical fiber 14 will reach from datum 20 to ferrule end 18. However, if the optical fiber 14 is larger than the minimum length by any amount within the tolerance range, the optical fiber 14 will buckle, generally as illustrated. The extent of the buckle and its specific path is dependent upon the length of the span 16 of the optical fiber 14. Span length also should include a small increment of length on each end of the optical fiber span 16 to accommodate any anchoring cement which may be extruded whenever the optical fiber 14 is cemented into the OSA 10 or the ferrule 12. This extruded cement will resist bending of the optical fiber 14. Additionally, the extruded cement may act to concentrate bending stresses and create an unintended bend radius at that point which may be small enough to cause optical fiber failure.

Wherever the tolerancing of the specified length of the optical fiber 14 is held tightly, for example such as +/−0.10 mm. for an optical fiber 14 having a span length of 13.46 mm., in order always to be able to span a predetermined distance d, d=12 mm., the cost of fabrication which includes cleaning and polishing both ends of the optical fiber 14 may be much greater than a similar optical fiber 14 specified to a length insuring a span length of 14 mm. +/−2.0 mm.

Whenever a larger or looser tolerance range is specified for the optical fiber 14 and in order to insure an adequate length to span the distance d, under worst case negative tolerance length, its nominal length l must be increased to accommodate the largest negative tolerance deviation.

As shown in FIG. 1, bends 1 and 3 are of substantially equal bend radii. The central bend 2 is opposite in direction but of substantially the same bend radius. By way of an example, with a worst case where a full +1.0 mm. tolerance increment is added to the nominal specified length, the bend radii of the three curves are 3.4 mm.

The 3.4 mm. bend radius of each of the three curves exceeds the minimum bend radius determined empirically by the method described earlier, not the bend radius specified by the manufacturer. The manufacturer's specified bend radius may be larger due to the fiber being enclosed in a jacket and due to the fact that the manufacturer may be compensating for a dynamic environment of use wherein movement and flexing of the optical fiber 14 may occur after installation.

If the bend radius of bends 1, 2, or 3 is significantly reduced as illustrated in FIG. 2 as a result of additional length of optical fiber 14 in the span length 16, the optical fiber 14 may crack or break. In addition to the cost of replacement of damaged optical fibers 14 which possibly could offset the cost savings associated with specifying a broader or looser tolerance range, the concern for reliability is a strong motivation to seek a better solution.

In the foregoing description, the minimum bend radius is assumed in the optical fiber 14 examples of FIGS. 1 and 2 to be 3.6 mm or less. One of skill in the art clearly recognizes that approaching or equaling the minimum bend radius will increase the possibility of optical fiber 14 failure and forming a bend with a radius smaller than the minimum bend radius and lead to failure or severely diminish the capabilities of the light conducting optical fiber 14.

Referring now to FIG. 3, the OSA's 10 (one a transmitter device, the other a receiver device) are connected by optical fiber 14 to their respective connection ferrules 12. The optical fibers 14 are illustrated as being of optimum length so as to form a straight connection between the OSA's 10 and the ferrules 12.

Due to the dimensional tolerances being a factor in the overall length of the optical fiber 14, this condition rarely occurs. The OSA's 10 are contained within an electro-optical transceiver assembly/enclosure 22.

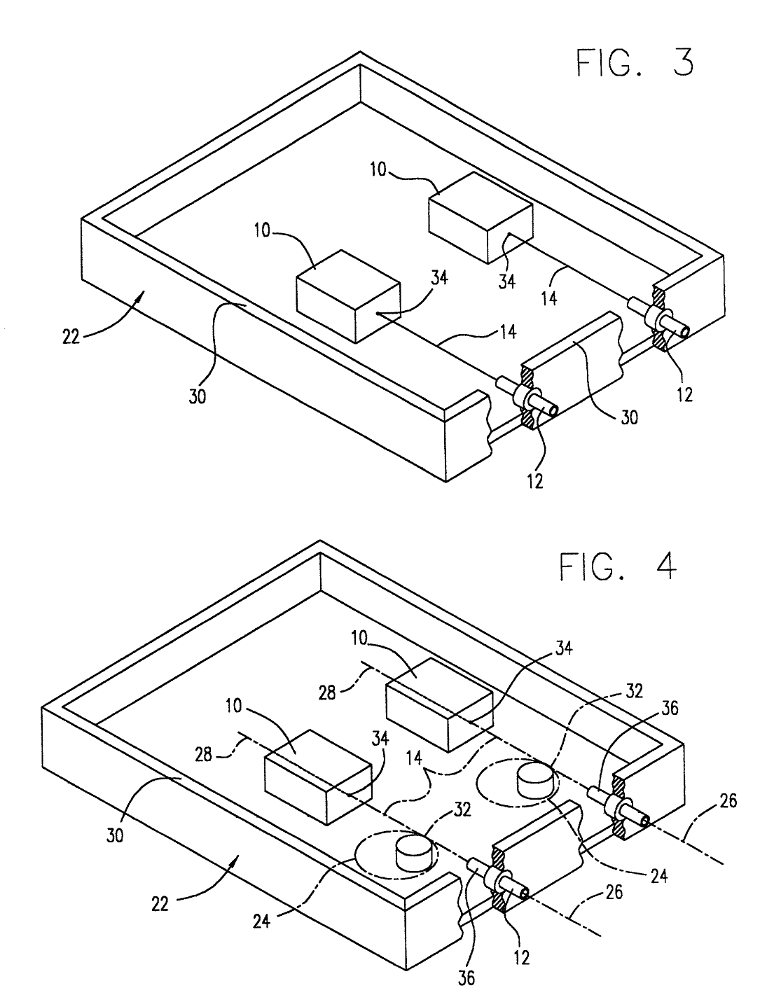

Refer now to FIG. 4. This figure illustrates the optical fiber 14 being of such a long length that each optical fiber 14 may be formed into a loop 24, and each loop 24 positioned to one side of the axis extending from the OSA's 10 to their respective ferrules 12. The heights of the ferrule axis 26 and the exit axis 28, along which the optical fiber 14 exits the OSA 10, may be closely controlled in order to substantially align the two axes 26, 28, if so desired.

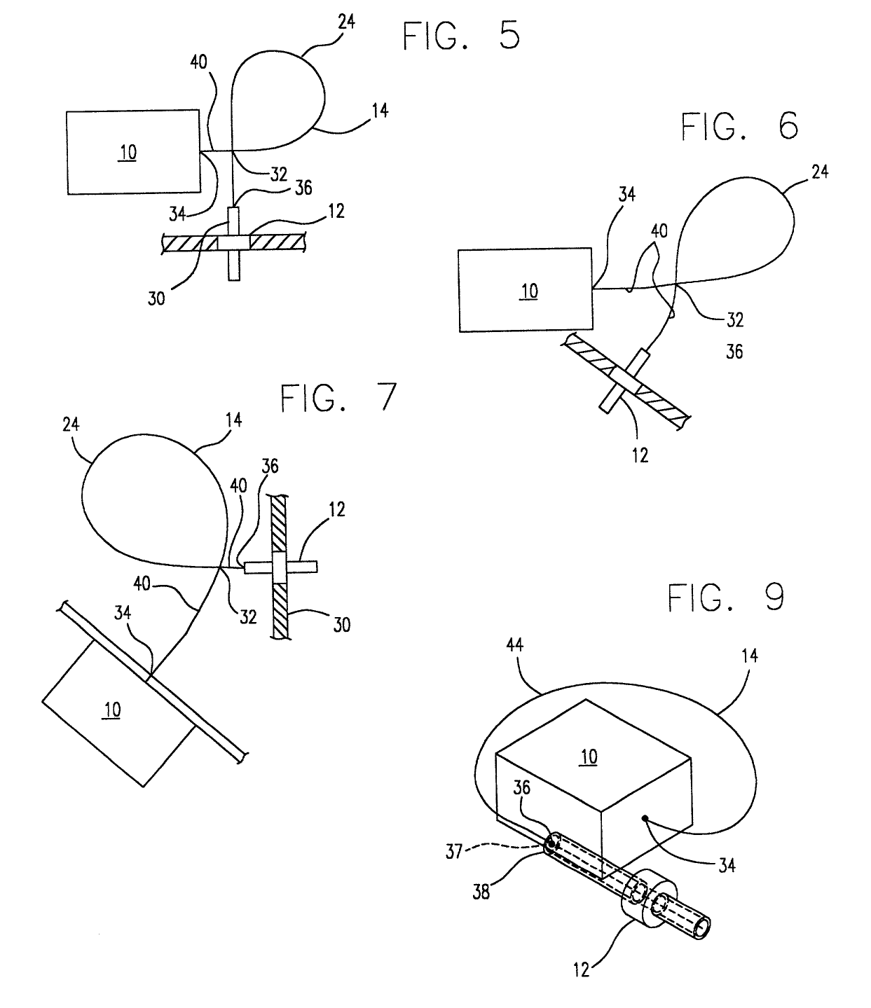

FIGS. 5, 6 and 7 illustrate various arrangements of the ferrule 12 and the OSA 10 showing that a looped optical fiber 14 may interconnect the respective devices with a loop 24 having a bend radius at all points thereon greater than the minimum bend radius of the optical fiber 14. As the optical fiber 14 is sized for length, any additional length will result in a loop 24 with larger bend radii. In all of the embodiments shown in FIGS. 4, 5, 6, and 7, the path of the optical fiber 14 creates a crossover point 32.

The path of the optical fiber 14 may be conveniently described as being made up of a plurality of exit runs 40. The segments of the optical fiber 14 which extend between the exit port 34 of the OSA 10 and the exit port 36 to the crossover point 32 are considered exit runs 40. Such exit runs 40 may be of uniform length or non-uniform lengths as the layout of the OSA 10 and its related ferrule 12 dictate.

The length of optical fiber 14 extending in a circuitous path between the exit runs 40, from the crossover point 32 around the circuitous path, and back to the crossover point 32, may be conveniently referred to as a loop run 42. With a substantial increase in the length of the loop run 42, the bend radius of the loop run 42 may be proportionately increased providing a further safety factor. Any such length increase will not cause a corresponding increase in the area required for the larger loop 42 as the radius increases at a rate of about ⅙ the increase in length for the full circular loop 42 and somewhat less for the partially circular loops 42.

The bend radius of the loop 24 need not be uniform; the only critical requirement for the bend radius is to be not less than the minimum bend radius of the optical fiber. Each optical fiber 14 may be formed into a loop 24, and each loop 24 positioned to one side of the axis extending from the OSA's 10 to their respective ferrules 12. The heights of the ferrule axis 26 and the exit axis 28, along which the optical fiber 14 exits the OSA 10, may be closely controlled in order to substantially align the two axes 26, 28, if so desired.

As the length of the loop ran 42 and, therefore, the overall length of the optical fiber 14 is increased from the minimum possible acceptable length, the importance of the upper end or+portion of the tolerance range is diminished and becomes negligible. Consequently, a tolerance range and the nominal length of optical fiber 14 may be specified to achieve a minimum cost for the optical fiber 14 by eliminating either very costly dimensional manufacturing control or expenses associated with sorting and rejecting completed items which fall outside an unduly tight tolerance range.

FIG. 8 illustrates the arrangement shown in FIG. 4 in an isometric view. In this view, the optical fiber 14 is laid to the side and permits low profile enclosures. Attached to the floor 46 of enclosure 22 is a post 48. The post 48 may be used to aid assembly of the OSA 10, ferrule 12 and, particularly, the optical fiber 14. It may prove advantageous to have a post 48 with a radius equal to slightly larger than the minimum bend radius of the optical fiber 14.

Alternatively, the post 48 may have a radius significantly smaller than the minimum bend radius of optical fiber 14 and be located close to a wall 30 of enclosure 22. The optical fiber loop 44 may be laid over the post 48, placing part of the loop run 42 between the wall 30 and the post 48, a rubber O-ring (not shown) is forced over the post 48 to retain the loop 44 in position as the enclosure 22 is closed with a cover (not shown).

An additional embodiment is illustrated in FIG. 9. In this embodiment, the plane in which the exit port 34 of the OSA 10 is in the same plane as the inner end face 38 of ferrule 12 and the exit port 36. The exit ports 34 and 36 thus are co-planar. An optical fiber 14 will form a helical curve 44 whenever interconnected between the optical devices 10, 12. The loop 44 will form a helix loop with a pitch equal to the distance between exit ports 3 and 36. Loop 44 may constitute substantially all of the exposed length of the optical fiber 14 with the exit runs 40 reduced to zero length. So long as the exposed length or loop run 42 of optical fiber 14 is formed with all curvature, therein having a bend radius greater than the minimum bend radius of the optical fiber 14, the loop run 42 length can be increased and tolerancing of the optical fiber 14 length can be substantially ignored, permitting specification with a tolerance range determined to secure the least cost for the item.

Numerical dimensions and tolerances are provided by way of example only and are not intended to limit the invention.

The foregoing description is set forth to provide those of skill in the art with the ability to practice the invention. This description is not intended to be used to limit the scope of the invention, but rather to provide a basis for the attached claims which define the scope of the invention.

Various embodiments of the invention have been disclosed with the understanding that various other modifications and changes may be made in the layout and configurations of the locating of the optical devices by those of ordinary skill in the art, without removing the modified device from the scope of the attached claims.

We claim:

1. An assembly for communication of optical signals comprising:
an optical sub-assembly for accomplishing said communication, said optical subassembly having an exit opening for passage of an optical fiber;
a rigid member supporting said optical sub-assembly in a predetermined fixed position within a predetermined tolerance range;
an enclosure substantially enclosing said rigid member and said optical subassembly, said enclosure including an opening therein for accepting a termination connector;
said optical sub-assembly and said opening separated by a predetermined distance;
said optical fiber termination connector disposed within said opening and attached to said enclosure;
an optical fiber having a minimum bend radius, said optical fiber terminated in said optical fiber termination connector;
said optical fiber further terminated within said optical sub-assembly, said optical fiber being of such a minimum length that said fiber extends between said optical subassembly and said optical fiber termination connector and forms a loop in the course of said optical fiber and whereby said bend radius of said fiber is not less than said minimum bend radius at any point.

2. The assembly of claim 1 wherein said opening in said enclosure and said exit opening of said optical sub-assembly are disposed coaxially.

3. The assembly of claim 1 wherein said opening in said enclosure and said exit opening of said optical sub-assembly are disposed so as to place axes of said optical fiber co-planar at the point of extension through said enclosure and at the point of extension from said optical sub-assembly.

4. The assembly of claim 3 wherein said axes intersect.

5. The assembly of claim 4 wherein said axes are parallel.

6. The assembly of claim 2 wherein said fiber forms a run thereof extending from each of both optical sub-assemblies and said termination connections, each said run having all bends therein exceeding said minimum bend radius.

7. The assembly of claim 2 wherein said runs pass each other with each of said runs forming an angle therebetween.

8. The assembly of claim 7 wherein said angle is an obtuse angle.

9. The assembly of claim 7 wherein said angle is an acute angle.

10. The assembly of claim 7 wherein said angle is a straight angle.

11. An assembly for optically connecting a first electro-optical assembly and a second optical assembly, said first and second assemblies spaced from each other by a first predefined distance, comprising:
a second retaining device disposed within said second optical assembly engaging and retaining a first end of a single optical fiber in a fixed relation to said second optical assembly;
a second retaining device within said first electro-optic device for retaining a second end of said single optical fiber, said optical fiber disposed to form a loop, and said optical fiber having a length exceeding a minimum length necessary to form said loop and to extend said optical fiber from said first electro-optic assembly to said second optical assembly with all portions of said optical fiber intermediate said assemblies having a bend radius not less than a predetermined minimum bend radius for said optical fiber, whereby said loop provides sufficient length to accommodate precisely spaced optical assemblies with an interconnection of an optical fiber with highly relaxed length tolerances.

12. A method of interconnecting an assembly disposed within a enclosure to a connector extending through an external wall of said enclosure comprising the steps of:
attaching an optical fiber having a predetermined minimum bend radius to an assembly at one end of said optical fiber attaching a second end of said optical fiber to a connector, forming a loop in said optical fiber, attaching said connector to said wall;
fixing said connector to said wall;
disposing said loop within confines of said enclosure and closing said enclosure, wherein said loop and any remainder of said optical fiber is deviated from a straight path only in bends having a bend radius exceeding said minimum bend radius, wherein optical elements which are fixed at a tightly specified inter-element distance are interconnected with an optical fiber of a length exceeding said inter-element distance plus 2πr where r is said predetermined minimum bend radius, added to the length of optical fiber contained with said optical assemblies.

13. A method of interconnecting an electro-optic assembly disposed within a enclosure to a connector extending through an external wall of said enclosure of claim 12 comprising the additional step of immobilizing said loop relative to said assemblies.

14. A method of interconnecting an electro-optic assembly disposed within a enclosure to a connector extending through an external wall of said enclosure of claim 12 comprising the additional step of restricting movement of said loop relative to said assemblies.

15. The method of interconnecting an assembly disposed within a enclosure to a connector extending through an external wall of said enclosure of claim 14 wherein said step of restricting includes encircling a rigid member within said enclosure.

16. The method of interconnecting an assembly disposed within a enclosure to a connector extending through an external wall of said enclosure of claim 15 wherein said step of restricting further includes trapping said loop in a position encircling said rigid member.
